(19) United States
(12) Patent Application Publication
(10) Pub. No.: US 2025/0284599 A1
(43) Pub. Date: Sep. 11, 2025

(54) SYSTEM AND METHOD FOR RECONSTRUCTING DATA FROM A DEGRADED RAID VOLUME USING AN ACCELERATOR ENGINE

(71) Applicant: Microchip Technology Incorporated, Chandler, AZ (US)

(72) Inventors: Anoop Pulickal Aravindakshan, Bangalore (IN); Raja Sekhar Reddy Bannuru, Bengaluru (IN)

(73) Assignee: Microchip Technology Incorporated, Chandler, AZ (US)

(21) Appl. No.: 18/660,355

(22) Filed: May 10, 2024

(30) Foreign Application Priority Data
Mar. 11, 2024 (IN) 202411017420

(51) Int. Cl. G06F 11/14

(52) U.S. Cl. CPC G06F 11/1469

(57) ABSTRACT

A system and method for reconstructing data from a degraded RAID storage device using an accelerator engine is disclosed. An article of manufacture may include a non-transitory memory having machine-readable instructions that, when executed by a processor, cause the processor to send a first command to a first storage device and a second storage device to trigger the first and second storage devices to write strip data to a memory in an accelerator engine. The instructions may also cause the processor to send a second command to the accelerator engine to perform an operation on the written strip data, the operation to reconstruct data stored on a third failed storage device. The first, second, and third storage devices may be part of a RAID volume. Further, the instructions may cause the processor to receive an output of the operation from the accelerator engine.

### PRIORITY

The present application claims priority to India Patent Application Number 202411017420, filed on Mar. 11, 2024, wherein the entire disclosure is incorporated herein by reference.

### TECHNICAL FIELD

The present disclosure relates to reconstructing data from a degraded redundant array of independent disks (RAID), e.g., where one drive of the RAID has failed, in particular, to using an accelerator engine and peer-to-peer direct memory access (DMA) capabilities to reconstruct data from a degraded RAID.

### BACKGROUND

When a group of drives is represented as a unit, i.e. the array is addressed as a unit, it may be called a RAID volume. The term RAID, while historically addressed to “disks,” may be used in relation to other storage devices, without limitation. Thus, the term RAID may be considered to refer to a redundant array of independent drives, such as solid state drives, or a redundant array of independent storage devices.

Conventional redundant array of independent disks (RAID) stacks running in hosts make use of host instructions for parity generation, which is a central processing unit (CPU) and memory intensive operation even on powerful x86_64 servers. CPU instructions may take up to two inputs and may not be efficient for larger strips of data. Some server CPUs use advanced vector extension (AVX) instructions for parity generation which adds pressure to host and host dynamic random access memory (DRAM) for any parity calculation operations.

Exclusively-OR (XOR) parity generation is one of the building blocks of RAID algorithms. XOR parity generation is also used in various other operations like error detection, encryption, and pseudo random number generators, without limitation. Software stacks running in host servers, normally use either regular CPU instructions or advanced vector instructions like AVX-256 or AVX-512 for XOR operations. Data flows that perform XOR on multiple strips of scattered data buffers, consume significant amount of host and memory controller bandwidth to perform this XOR operation. Traditional hardware (HW) RAID architecture may be a bottleneck for performance when scaling via high-performance nonvolatile memory express (NVMe) drives.

Peripheral Component Interconnect Express (PCIe) is a high-speed serial computer expansion bus standard that replaces the older PCI, PCI-X, and Accelerated Graphics Port (AGP) bus standards. A PCIe root complex connects a PCIe end point with the CPU and memory subsystems to route communications between the connected devices. A PCIe end point or switch does not connect with the CPU or memory, but rather connects through the PCIe root complex. PCIe uses point-to-point topology, allowing for faster communication between devices. Motherboards and systems that support PCIe, use PCIe devices of different sizes, such as ×1, ×4, ×8, or ×16, which refers to the number of lanes they use. PCIe devices connect to the motherboard or system using a PCIe slot so the device may be recognized by the motherboard or system.

Non-volatile memory express (NVMe) is an open, logical-device interface specification for accessing a computer's non-volatile storage media usually attached via the PCIe bus. NVMe may be used with NAND flash memory that comes in PCIe add-in cards.

However, existing RAID stacks uses the DRAM in the host for transfer buffers and the host for computations used to reconstruct a degraded RAID storage device. These computations use significant bandwidth of the host's memory and impair the host's ability to execute other applications.

### SUMMARY OF THE INVENTION

Aspects provide systems and methods for system for reconstructing data from a degraded redundant array of independent disks (RAID) volume using an accelerator engine. An example may include an article of manufacture. The article of manufacture may include a non-transitory memory having machine-readable instructions that, when executed by a processor, cause the processor to send a first command to a first storage device and a second storage device to trigger the first and second storage devices to write strip data to a memory in an accelerator engine. The instructions may also cause the processor to send a second command to the accelerator engine to perform an operation on the written strip data, the operation to reconstruct data stored on a third failed storage device. The first, second, and third storage devices may be part of a RAID volume. Further, the instructions may cause the processor to receive an output of the operation from the accelerator engine.

In combination with any of the above examples, the instruction may further cause the processor to send the first command, send the second command, and receive the output using a Peripheral Component Interconnect Express (PCIe) bus including a PCIe root complex.

In combination with any of the above examples, the operation may be an XOR operation on the written strip data.

In combination with any of the above examples, the first and second storage devices and the accelerator engine may communicate using peer-to-peer direct memory access.

In combination with any of the above examples, the accelerator engine and the first and second storage devices may be PCIe end points.

In combination with any of the above examples, the instruction may further cause the processor to receive a message from the first and second storage devices indicating that the first and second storage devices have finished writing strip data to the memory in the accelerator engine. The message may trigger the processor to send the second command.

Alone or in combination with any of the above examples, examples of the present disclosure may include a method. The method may include sending a first command to a first storage device and a second storage device to trigger the first and second storage devices to write strip data to a memory in an accelerator engine. The first and second storage devices may be part of a RAID volume. The method may additionally include sending a second command to the accelerator engine to perform an operation on the written strip data. The operation may be to reconstruct data stored on a third failed storage device of the RAID volume. The method may further include receiving an output of the operation from the accelerator engine.

In combination with any of the above examples, the method may further include sending the first command, sending the second command, and receiving the output occurs using a Peripheral Component Interconnect Express (PCIe) bus including a PCIe root complex.

In combination with any of the above examples, the PCIe root complex may be to route communications from the first and second storage devices and the memory in the accelerator engine based on a base address register (BAR) of the memory in the accelerator engine.

In combination with any of the above examples, the operation may be an XOR operation on the written strip data.

In combination with any of the above examples, the first command may instruct the first and second storage devices to communicate with the accelerator engine using peer-to-peer direct memory access.

In combination with any of the above examples, the accelerator engine and the first and second storage devices may be PCIe end points.

In combination with any of the above examples, the method may further include receiving a message from the first and second storage devices indicating that the first and second storage devices have finished writing strip data to the memory in the accelerator engine. The message may trigger sending of the second command.

Alone or in combination with any of the above examples, examples of the present disclosure may include a system. The system may include a memory bus, an accelerator engine circuit coupled to the memory bus, and a host coupled to the memory bus. The host may include a processor and a non-transitory memory including machine-readable instructions that, when executed by the processor, cause the processor to send a first command to a first storage device and a second storage device coupled to the memory bus to trigger the first and second storage devices to write strip data to a memory in the accelerator engine circuit. The instructions may also cause the processor to send a second command to the accelerator engine circuit to perform an operation on the written strip data. The operation may be to reconstruct data previously stored on a third failed storage. The first, second, and third storage devices may be part of a RAID volume. The instructions may further cause the processor to receive an output of the operation from the accelerator engine circuit.

In combination with any of the above examples, the memory bus may be a Peripheral Component Interconnect Express (PCIe) bus including a PCIe root complex.

In combination with any of the above examples, the PCIe root complex may be to route communications from the first and second storage devices and the memory in the accelerator engine circuit based on a base address register (BAR) of the memory in the accelerator engine circuit.

In combination with any of the above examples, the operation may be an XOR operation on the written strip data.

In combination with any of the above examples, the first and second storage devices and the accelerator engine circuit may communicate using peer-to-peer direct memory access.

In combination with any of the above examples, the accelerator engine circuit and the first and second storage devices may be PCIe end points.

In combination with any of the above examples, the instructions may further cause the processor to receive a message from the first and second storage devices indicating that the first and second storage devices have finished writing strip data to the memory in the accelerator engine circuit. The message may trigger the processor to send the second command.

Although example embodiments have been described above, other variations and embodiments may be made from this disclosure without departing from the spirit and scope of these embodiments.

### BRIEF DESCRIPTION OF THE DRAWINGS

The figures illustrate examples of systems and methods.

FIG. 1 illustrates a block diagram of a system for reconstructing data from a degraded RAID volume using an accelerator engine, according to examples of the present disclosure;

FIG. 2 illustrates a method performed for reconstructing data from a degraded RAID volume using an accelerator engine, according to examples of the present disclosure; and

FIG. 3 illustrates a method performed for reconstructing data from a degraded RAID volume using an accelerator engine, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, a system and method for reconstructing data from a degraded redundant array of independent disks (RAID) volume using an accelerator engine is provided. A RAID volume may be degraded when a storage device that is a part of the RAID volume has failed. As described above, a RAID volume is a logical device created utilizing multiple storage devices, such as drives, or disks, without limitation. The system and method reconstructs data from a failed RAID volume using peer-to-peer communications (e.g., Peripheral Component Interconnect Express (PCIe) peer-to-peer direct memory access (DMA) capability) such that an accelerator engine reconstructs data in the event of a degraded RAID volume without using memory in a host as a transfer buffer. Using the accelerator engine for data reconstruction may reduce the use of memory on a host and improve the performance of a degraded RAID volume. Memory in the accelerator engine may be used as a transfer buffer instead of memory in the host and may reduce overhead at the host.

Aspects include features disclosed in Indian Patent Application No. 202311056027 filed on Aug. 21, 2023 and U.S. patent application Ser. No. 18/527,579 filed on Dec. 4, 2023, incorporated herein in its entirety for all purposes.

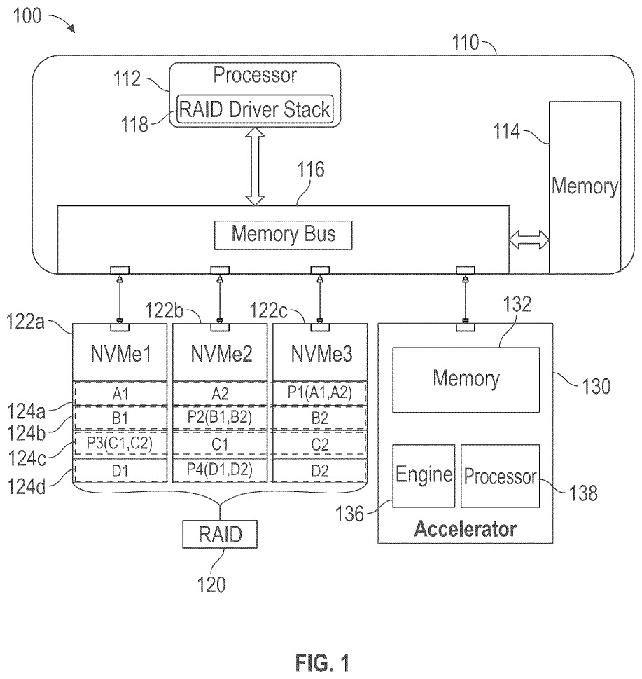

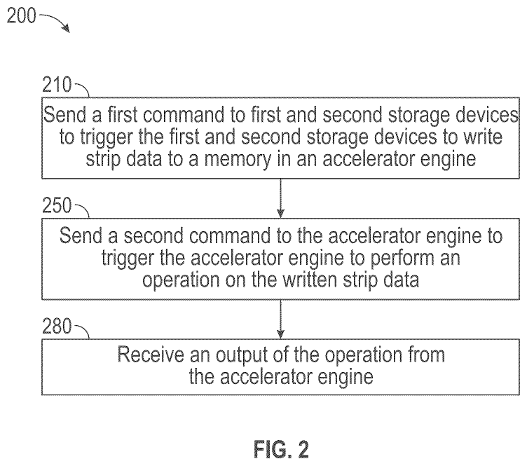

FIG. 1 illustrates a block diagram of a system for reconstructing data from a degraded RAID volume using an accelerator engine, according to examples of the present disclosure. System 100 may include host 110 which may include processor 112, memory 114, and memory bus 116. Processor 112 may write data to memory 114 and may read data from memory 114 using memory bus 116. Memory 114 may be a non-transitory memory, such as non-volatile random-access memory (NVRAM), including machine-readable instructions that when executed by processor 112, may cause processor 112 to perform one or more actions as described herein. Processor 112 may be a central processing unit (CPU), a general purpose processor, a specific purpose processor, a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. Processor 112 may drive signals onto memory bus 116 to read data from storage devices 122a, 122b, and 122c (collectively “storage devices 122”) and may drive signals onto memory bus 116 to write data to storage devices 122. Processor 112 may include RAID driver stack 118 to manage storage devices 122 and accelerator engine 130. Storage devices 122 may be controlled as RAID volume 120 responsive to operation of RAID driver stack 118. As described with respect to FIG. 2, when performing data reconstruction operations (e.g., eXclusive OR (XOR) operations), RAID driver stack 118 may call a non-volatile memory express (NVMe) offload command to perform the operation. The NVMe offload command may be vendor defined. In doing so, instead of using memory 114 in host 110 for transfer buffers during data reconstruction operations, RAID driver stack 118 will use memory 132 in accelerator engine 130.

Memory bus 116 may receive data from processor 112 and may transmit data to one or more circuits coupled to memory bus 116. Memory bus 116 may be a Peripheral Component Interconnect Express (PCIe) bus or another bus type not specifically mentioned. Memory bus 116 may be a PCIe root complex that is the root of a hierarchy that connects with host 110, RAID volume 120, and accelerator engine 130. Host 110, storage devices 122 in RAID volume 120, and accelerator engine 130 may be PCIe end points. A PCIe end point does not connect directly with processor 112 or memory 116, but rather connects through memory bus 116.

Storage devices 122 may be non-transitory storage devices, such as solid state drives or hard disk drives, including but not limited to Dynamic Random Access Memory (DRAM), Non-Volatile Memory (NVM), Embedded Non-Volatile Memory (eNVM), Non-Volatile Memory Express (NVMe), or another type of non-transitory storage not specifically mentioned. A given storage device 122 may include a circuit to move data to and from the storage device 122. Storage devices 122 may use open, logical-device interface specifications for accessing non-volatile storage media, wherein the specifications may include NVMe or non-volatile memory host controller interface specification (NVMHCIS). Memory bus 116 may facilitate data transmission to and from storage devices 122. Processor 112 may move data through memory bus 116 to storage devices 122, and processor 112 may receive data from storage devices 122 through memory bus 116. Additionally, storage devices 122 and accelerator engine 130 may communicate with one another using memory bus 116.

RAID volume 120 may be a redundant array of independent disks formed of storage devices 122. In some examples, RAID volume 120 may be a RAID-5 system including a minimum of three storage devices 122. While there is no limitation as to the maximum number of drives, for illustration purposed three storage devices will be utilized, without limitation. RAID volume 120 may use disk striping with parity when storing information. The data and parity information may be striped evenly across storage devices 122 in RAID volume 120. As an example of disk striping, in a RAID volume with three storage devices and assuming each strip is 16 KB, each row of the RAID volume will contain two strips of data and one strip of parity information. The two strips of data are collectively referred to as a “stripe,” and will be accompanied by one strip of parity information for a given stripe. For example, when RAID volume 120 includes three storage devices 122, a stripe may include data stored on two of the three storage devices 122 and parity information stored on the third of the three storage devices 122. Specifically, as illustrated in FIG. 1, stripe 124a may include data A1 and A2, stored on storage devices 122a and 122b, respectively, and parity information P1(A1, A2) for data A1 and A2 stored on storage device 122c. Any two of the three storage devices 122 may store the data portion of the stripe and the remaining storage device 122 may store the parity information. As shown in FIG. 1, parity information for stripe 124b is stored on storage device 122b, parity information for stripe 124c is stored on storage device 122a and parity information for stripe 124d is stored on storage device 122b. Striping may allow data writes and reads to occur in parallel to multiple storage devices 122 and may avoid any single storage device 122 being a bottleneck. Striping also may enable users to reconstruct data in the event one of storage devices 122 fails, i.e. RAID volume 120 is degraded. RAID volume 120 may be considered degraded if any one storage device 122 of RAID volume 120 is missing or has failed.

System 100 may also have one or more accelerator engines 130 coupled to host 110 and storage devices 122 through memory bus 116. Accelerator engine 130 may be used to offload computational operations from host 110 to a PCIe end point using NVMe transport protocol instruction communications and DMA data communications. Accelerator engine 130 may include memory 132, engine 136, and processor 138. Accelerator engine 130 may support XOR offload commands for reconstructing data stored on a failed storage device 122 of a degraded RAID volume 120. Accelerator engine 130 supports XOR offload commands by providing memory 132 in accelerator engine 130 that may be used as a buffer during data reconstruction instead of memory 114 in host 110. Specifically, memory 132 may include instructions to create a region of memory 132, such as a dynamic random access memory (DRAM) window that is exposed to a RAID driver on host 110 as a base address register (BAR) (e.g., BAR4). Memory 132 may be double data rate (DDR) memory or double data rate synchronous dynamic random access memory (DDR SDRAM), without limitation. Engine 136 may be an engine or circuit to perform an operation, such as a parity generation engine, or a parity generation circuit, and may be used to reconstruct data based on parity information. Engine 136 may perform XOR operations. Processor 138 may be a general purpose processor, a specific purpose processor, a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein.

When a storage device 122 in RAID volume 120 fails, resulting in RAID volume 120 being degraded, system 100 may reconstruct the data from the failed storage device 122 using peer-to-peer direct memory access communications between the remaining storage devices 122 (e.g., the storage devices 122 that are not failed) and memory 132 in accelerator engine 130 via memory bus 116. When memory bus 116 is a PCIe bus, data from a failed storage device 122 may be reconstructed using PCIe peer-to-peer communication which enables two PCIe devices (e.g., storage devices 122 and accelerator engine 130) to directly transfer data between each other without using memory 116 in host 110 as a temporary storage.

For example, in an example where storage device 122b has failed, the reconstruction of the data from storage device 122b may begin when processor 112 writes to a doorbell register of storage devices 122a and 122c using memory bus 116. Doorbell registers provide a way for one device coupled to memory bus 116 to send a message to another device coupled to memory bus 116 without using an interrupt. Therefore, when processor 112 writes to the doorbell register of storage devices 122a and 122c, the doorbell register indicates to a processor or control circuit of the storage devices 122a and 122c that a command is pending.

The doorbell register write may cause storage devices 122a and 122c to read a first command from host 110 using memory bus 116. The first command may cause storage devices 122a and 122c to write strip data to memory 132. The strip data written to memory 132 may be the data associated with a given data strip. For example, when the given data stripe is data stripe 124a, storage device 122a may write data A1 to memory 132 and storage device 122c may write parity information P1(A1, A2) to memory 132. Storage devices 122a and 122c may write the strip data to memory 132 using direct memory access (DMA) over memory bus 116 to a region of memory 132 that may be exposed to storage devices 122a and 122c as BAR4.

After writing strip data to memory 132, storage devices 122a and 122c may send a message to a RAID driver stack via memory bus 116 indicating that storage devices 122a and 122c have finished writing strip data. The message may be in the form of an interrupt or a poll. For example, the message may be a message signaled interrupt (MSI) signal, such as MSI or MSI-X. In response to the message indicating that storage devices 122a and 122c have finished writing strip data, host 110 initiates a second command, which second command is addressed to accelerator engine 130, e.g., by performing a write to a doorbell register at accelerator engine 130. The second command may be an XOR command. The second command may be sent from host 110 to accelerator engine 130 via memory bus 116.

In response to the write to the doorbell register of accelerator engine 130, accelerator engine 130 may pull the second command from host 110 via memory bus 116. Engine 136 in accelerator engine 130 then may perform the operation specified in the second command on the strip data written to memory 132 by storage devices 122a and 122c. For example, the second command may be an XOR command. The result of the second command is the reconstructed data from failed storage device 122b.

Once the accelerator engine 130 has reconstructed the data from storage device 122b, accelerator engine 130 may send the reconstructed data to memory 114 via memory bus 116. After sending the reconstructed data to memory 114, accelerator engine 130 may also send a message to a RAID driver stack over memory bus 116 indicating that data reconstruction is complete. After receiving the message, the RAID driver stack may perform any further processing on the reconstructed data. The message may be in the form of a poll or an interrupt, such as an MSI or MSI-X.

The process described above may use peer-to-peer DMA operations between storage devices 122a and 122c and accelerator engine 130 without sending strip data to memory 114, and without requiring processor 112 to perform the XOR, or other, operation on data to recover the lost data, thus increasing the efficiency and reducing overhead in host 110 when reconstructing data from a degraded storage device.

FIG. 2 illustrates a method performed for reconstructing data from a degraded RAID volume using an accelerator engine circuit, according to examples of the present disclosure. Method 200 may be implemented using any of the components shown in FIG. 1, such as host 110, RAID volume 120, and accelerator engine 130, by themselves or in combination, or any other component operable to implement method 200. Although examples have been described above, other variations and examples may be made from this disclosure without departing from the spirit and scope of these disclosed examples.

Method 200 begins at block 210 where the RAID driver stack may send a first command to the storage devices that have not failed, or causing an error, (hereinafter “functional storage devices”) to fetch strip data from the functional storage devices and instruct the functional storage devices to write strip data to a memory in an accelerator engine circuit, such as memory 132 in accelerator engine 130 shown in FIG. 1. The RAID driver stack may send the first command after initiating a strip read to a RAID volume and discovering that a storage device of the RAID volume has failed, or errored. In response to receiving the first command, the functional storage devices may write strip data to the memory in the accelerator engine circuit.

At block 250, the RAID driver stack may send a second command, such as an XOR command, to the accelerator engine circuit to trigger the accelerator engine circuit to perform an operation, e.g., an XOR operation without limitation, on the strip data written at block 210. The second command may be sent utilizing a memory write transaction to a doorbell register in the accelerator engine circuit and be a vendor defined NVMe XOR command. In response to receiving the second command, the accelerator engine circuit may perform an operation, such as an XOR or other operation, on the strip data from the memory in the accelerator engine circuit.

At block 280, the RAID driver stack may receive the output of the operation from the accelerator engine circuit. The accelerator engine circuit may write the output of the operation to memory in the host. The accelerator engine circuit may write the output of the operation to memory in the host by DMA. The output of the XOR operation may be a reconstruction of the data stored on the failed, or errored, storage device.

Although FIG. 2 discloses a particular number of operations related to method 200, method 200 may be executed with greater or fewer operations than those depicted in FIG. 2. In addition, although FIG. 2 discloses a certain order of operations to be taken with respect to method 200, the operations comprising method 200 may be completed in any suitable order.

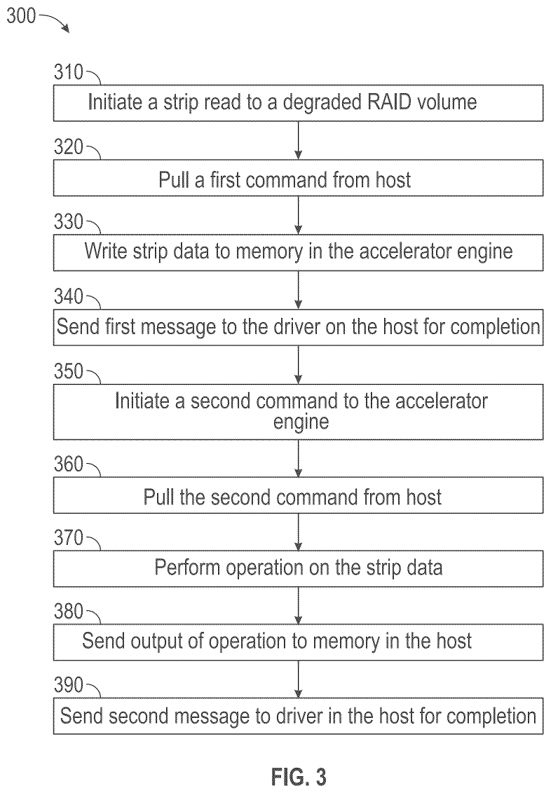

FIG. 3 illustrates a method performed for reconstructing data from a degraded RAID volume using an accelerator engine circuit, according to examples of the present disclosure. Method 300 may be implemented using any of the components shown in FIG. 1, such as host 110, RAID volume 120, and accelerator engine 130, by themselves or in combination, or any other component operable to implement method 300. Although examples have been described above, other variations and examples may be made from this disclosure without departing from the spirit and scope of these disclosed examples.

Method 300 begins at block 310 where the RAID driver stack may initiate a strip read of a RAID volume, such as RAID volume 120 shown in FIG. 1, and may discover that the RAID volume is degraded because one of the constituent storage devices has failed or errored. The RAID driver stack may initiate NVMe commands to storage devices in the RAID volume over a memory bus, such as memory bus 116 shown in FIG. 1, and write to a doorbell register in the storage devices that have not failed. For example, referring to FIG. 1, if storage device 122b has failed, the RAID driver stack may write to a doorbell register in storage devices 122a and 122c. The doorbell register may inform the storage devices that have not failed of a pending command and trigger the storage devices that have not failed to pull a command from the host to cause storage devices that have not failed, e.g., storage devices 122a and 122c, to write strip data to memory in the accelerator engine circuit, such as accelerator engine 130 shown in FIG. 1, as described with respect to blocks 320 and 330.

At block 320, the storage devices that received the doorbell register write (at block 210) may, at least partially responsive to the doorbell register write, pull the first command using a memory read to memory in the host, such as memory 114 shown in FIG. 1. The first command may instruct the storage devices to write strip data to memory in the accelerator engine circuit, as described with respect to block 330.

At block 330, the storage devices that received the doorbell register write may trigger direct memory access (DMA) to write strip data to memory in the accelerator engine circuit. The memory in the accelerator engine circuit may include a DDR region exposed to the storage devices exposed as a BAR.

At block 340, the storage devices that received the doorbell register write may send a first message to the RAID driver stack indicated that the command has completed. The message may communicate to the RAID driver stack that the storage devices have completed writing the strip data to the memory in the accelerator engine circuit and the RAID driver stack may proceed with the data reconstruction process. The first message may be in the form of an interrupt, such as an MSI or MSI-X, or a poll.

At block 350, the RAID driver stack may initiate a second command, at least partially in response to receiving the first message (at block 340), addressed to the accelerator engine circuit, by writing to a doorbell register in the accelerator engine circuit. The second command may be an XOR command and may be a vendor defined NVMe command.

At block 360, in response to the doorbell register write (block 350), the accelerator engine circuit may pull the second command from the host. The second command may be in memory at the host or any BAR.

At block 370, an engine, or circuit, in the accelerator engine circuit may, at least partially responsive to the second command, perform an operation on the strip data from the memory in the accelerator engine circuit. The operation may be an XOR operation. The strip data used for the XOR operation may be the data written to the memory in the accelerator engine circuit at block 330.

At block 380, the accelerator engine circuit may send the output of the operation (from block 370) to memory in the host. The accelerator engine circuit may write the output of the operation to memory in the host by DMA. The output of the operation may be a reconstruction of the data stored on the failed, or errored, storage device.

At block 390, the accelerator engine circuit may send a second message to the host indicating that the command has been completed. The second message may be in the form of an interrupt, such as an MSI or MSI-X, or a poll.

Although FIG. 3 discloses a particular number of operations related to method 300, method 300 may be executed with greater or fewer operations than those depicted in FIG. 3. In addition, although FIG. 3 discloses a certain order of operations to be taken with respect to method 300, the operations comprising method 300 may be completed in any suitable order.

Although examples have been described above, other variations and examples may be made from this disclosure without departing from the spirit and scope of these disclosed examples.

1. An article of manufacture comprising:
a non-transitory memory including machine-readable instructions that, when executed by a processor, cause the processor to:
send a first command to a first storage device and a second storage device to trigger the first and second storage devices to write strip data to a memory in an accelerator engine;
send a second command to the accelerator engine to perform an operation on the written strip data, the operation to reconstruct data stored on a third failed storage device, wherein the first, second, and third storage devices are part of a RAID volume; and
receive an output of the operation from the accelerator engine.

2. The article of manufacture of claim 1, wherein the processor is to send the first command, send the second command, and receive the output using a Peripheral Component Interconnect Express (PCIe) bus including a PCIe root complex.

3. The article of manufacture of claim 1, wherein the operation is an XOR operation on the written strip data.

4. The article of manufacture of claim 1, wherein the first and second storage devices and the accelerator engine communicate using peer-to-peer direct memory access.

5. The article of manufacture of claim 4, wherein the accelerator engine and the first and second storage devices are PCIe end points.

6. The article of manufacture of claim 1, wherein the processor is to receive a message from the first and second storage devices indicating that the first and second storage devices have finished writing strip data to the memory in the accelerator engine; and
wherein the message triggers the processor to send the second command.

7. A method, comprising:
sending a first command to a first storage device and a second storage device to trigger the first and second storage devices to write strip data to a memory in an accelerator engine, wherein the first and second storage devices are part of a RAID volume;
sending a second command to the accelerator engine to perform an operation on the written strip data, the operation to reconstruct data stored on a third failed storage device of the RAID volume; and
receiving an output of the operation from the accelerator engine.

8. The method of claim 7, wherein sending the first command, sending the second command, and receiving the output occurs using a Peripheral Component Interconnect Express (PCIe) bus including a PCIe root complex.

9. The method of claim 8, wherein the PCIe root complex is to route communications from the first and second storage devices and the memory in the accelerator engine based on a base address register (BAR) of the memory in the accelerator engine.

10. The method of claim 7, wherein the operation is an XOR operation on the written strip data.

11. The method of claim 7, wherein the first command instructs the first and second storage devices to communicate with the accelerator engine using peer-to-peer direct memory access.

12. The method of claim 8, wherein the accelerator engine and the first and second storage devices are PCIe end points.

13. The method of claim 7, comprising receiving a message from the first and second storage devices indicating that the first and second storage devices have finished writing strip data to the memory in the accelerator engine; and
wherein the message triggers sending of the second command.

14. A system, comprising:
a memory bus;
an accelerator engine circuit coupled to the memory bus; and
a host coupled to the memory bus, the host including a processor and a non-transitory memory including machine-readable instructions that, when executed by the processor, cause the processor to:
send a first command to a first storage device and a second storage device coupled to the memory bus to trigger the first and second storage devices to write strip data to a memory in the accelerator engine circuit;
send a second command to the accelerator engine circuit to perform an operation on the written strip data, the operation to reconstruct data previously stored on a third failed storage, wherein the first, second, and third storage devices are part of a RAID volume; and
receive an output of the operation from the accelerator engine circuit.

15. The system of claim 14, wherein the memory bus is a Peripheral Component Interconnect Express (PCIe) bus including a PCIe root complex.

16. The system of claim 15, wherein the PCIe root complex is to route communications from the first and second storage devices and the memory in the accelerator engine circuit based on a base address register (BAR) of the memory in the accelerator engine circuit.

17. The system of claim 14, wherein the operation is an XOR operation on the written strip data.

18. The system of claim 14, wherein the first and second storage devices and the accelerator engine circuit communicate using peer-to-peer direct memory access.

19. The system of claim 15, wherein the accelerator engine circuit and the first and second storage devices are PCIe end points.

20. The system of claim 14, wherein the processor is to receive a message from the first and second storage devices indicating that the first and second storage devices have finished writing strip data to the memory in the accelerator engine circuit; and
wherein the message triggers the processor to send the second command.
